(19) United States
(12) Patent Application Publication
(10) Pub. No.: US 2004/0028862 A1
(43) Pub. Date: Feb. 12, 2004

(54) Fibrous closure for heat-shrinkable covers

(76) Inventors: Douglas Neil Burwell, Georgetown (CA); Alfredo Andrenacci, Scarborough (CA); William Peter Buckley, Toronto (CA)

Correspondence Address: SHLESINGER, ARKWRIGHT & GARVEY LLP, 3000 SOUTH EADS STREET, ARLINGTON, VA, 22202, US

(21) Appl. No.: 10/216,653

(22) Filed: Aug. 12, 2002

(51) Int. Cl. B32B 9/00; B32B 31/26

(52) U.S. Cl. 428/40.1; 156/85; 156/86

(57) ABSTRACT

A fibrous closure comprises a dimensionally stable, heat resistant fibrous backing layer and a layer of high shear strength pressure sensitive adhesive. The closure is used in conjunction with a heat shrinkable, wraparound sleeve for sealing cable jackets, connectors and joints between lengths of pipe or other elongate objects. The sleeve is wrapped around the object such that its ends overlap. The closure is then applied over the overlapping ends of the sleeve to prevent slippage of the overlapping ends during heat shrinking, and to prevent subsequent creeping of the overlap joint due to hoop stresses in the shrunken sleeve. The closure avoids use of a relatively inflexible polymeric backing layer, and is therefore able to conform to objects having a relatively small diameter or irregular shape.

### FIELD OF THE INVENTION

This invention relates to closures for joining the ends of polymeric sheet materials, and specifically relates to closures for joining and sealing the overlapping edges of dimensionally recoverable covers, such as heat-shrinkable polymeric sleeves.

### BACKGROUND OF THE INVENTION

Thin-walled polymeric sleeves are known for sealing cable jackets, connectors and the joints between lengths of pipe or other elongate objects, for example to provide environmental sealing protection. Heat-shrinkable tubular sleeves formed by extrusion are commonly used for this purpose, but suffer from the disadvantage that they require access to a free end, which is often not readily available. In addition, it is difficult to produce heat-shrinkable sleeves by extrusion, particularly where the sleeves are for relatively large diameter pipes.

To overcome these difficulties, so called “wraparound sleeves” have been developed. These wraparound sleeves are more versatile than tubular sleeves in that they can be readily applied to regularly-shaped, elongate articles, including cables and large diameter pipes, which may or may not have an accessible exposed end.

Wraparound sleeves typically comprise an outer layer of heat-shrinkable polymeric material and an inner layer of mastic or adhesive, which adheres the sleeve to the substrate and fills any voids. The sleeve is wrapped around the substrate such that its ends overlap. The sleeve is subsequently heated, for example by a torch, causing it to shrink into intimate contact with the substrate.

In order to prevent slippage of the overlapping ends during heat shrinking, and to prevent subsequent creeping of the overlap joint due to hoop stresses in the shrunken sleeve, a closure patch is applied to the overlap joint prior to heat shrinking of the sleeve.

A number of different types of closure patches are known. One type of closure comprises a polymeric backing material to which a high shear strength hot melt adhesive is applied. In order to provide the closure with dimensional stability, the closure also incorporates a layer of reinforcing material, such as a mesh or fabric. One example of this type of closure is disclosed in U.S. Pat. No. 4,200,676 (Caponigro et al.). This patent discloses a layer of crosslinked hot melt adhesive applied to a polymer layer which is reinforced with glass cloth. The reinforcing layer may either be sandwiched between two layers of polymer or the polymer may be extruded about the reinforcement. Strips of pressure sensitive adhesive or two-sided tape are provided on the adhesive layer for initial adhesion to the wraparound sleeve. U.S. Pat. No. 4,803,104 (Peigneur et al.) discloses a closure patch comprising a laminate of two polymeric layers with an intermediate reinforcing layer. One polymeric layer functions as a backing, and the second layer contacts and bonds to the overlapping edges of the wraparound sleeve. U.S. Pat. No. 4,961,978 (Doheny, Jr. et al.) discloses a closure comprising a dimensionally stable backing layer, a pressure sensitive adhesive, and a heat-shrinkable film having an area smaller than that of the adhesive layer, the heat-shrinkable film layer preferably comprising the same material as the wraparound sleeve.

Another type of closure is known which does not utilize a reinforcing layer. One example of such a closure is disclosed in U.S. Pat. No. 4,472,468 (Tailor et al.). This patent discloses a wraparound sleeve with an integral closure, the sleeve comprising a heat-shrinkable polymeric layer and a hot melt adhesive layer. The hot melt adhesive layer covers only a portion of the sleeve, leaving a bare area near one end. This bare area forms a closure which welds to the heat-shrinkable sleeve in the region of the overlap joint. U.S. Pat. No. 5,175,032 (Steele et al.) discloses a closure in which the hot melt adhesive layer is eliminated. The polymeric layer is merely provided with strips of a pressure sensitive hold down adhesive near its ends to retain the closure patch in place while it is being fused to the wraparound sleeve. U.S. Pat. No. 5,411,777 (Steele et al.) discloses a sleeve with an integral closure which is provided with a removable susceptor strip to permit induction heating of the polymer layer.

Known closures for wraparound sleeves suffer from disadvantages which limit their utility. For example, the polymeric backing layers of known closures tend to be relatively thick and stiff. While the backing layer may require only limited flexibility where the closure is used for sealing wraparound sleeves to regularly shaped articles of relatively large diameter (typically greater than 12 inches), such closures may not be flexible enough to conform to the dimensions of objects having an irregular shape or a relatively small diameter. As a result, peeling of the closure can occur. Furthermore, the application of multi-layered closures with relatively thick polymeric backing layers requires large amounts of heat in cause the inner adhesive layer to flow, and bond the closure to the wraparound sleeve. As this heating is typically performed in the field with a gas torch, it is difficult to apply the correct amount of heat, and failure of the closure may result.

Accordingly, the need exists for an improved closure for wraparound heat-shrinkable sleeves.

### SUMMARY OF THE INVENTION

The present invention overcomes the disadvantages of the prior art by providing a fibrous closure for a wraparound sleeve comprising a dimensionally stable heat resistant fibrous backing layer and a layer of high shear strength pressure sensitive adhesive. The closure of the present invention avoids use of a polymeric backing layer, and is therefore able to conform to substrates of relatively small diameter or of irregular shape.

The fibrous backing layer is dimensionally stable so as to prevent deformation of the closure patch during heat shrinking of the wraparound sleeve, and is flame resistant and temperature resistant so that it will not be damaged during heating of the closure patch by a flame. Most preferably, the fibrous backing material comprises an inorganic fabric such as a mat of woven or non-woven glass fibers.

The pressure sensitive adhesive is preferably partially or completely crosslinked and is highly temperature resistant, flame resistant and shear resistant. Contrary to the teachings of the prior art, the inventors have discovered that pressure sensitive adhesives can be effective to provide initial adhesion of the closure to the wraparound sleeve and also to permanently bond the closure to the sleeve.

In another aspect, the present invention provides a wraparound sleeve comprised of an outer heat-shrinkable polymeric material and an inner adhesive layer. The wraparound sleeve is preferably in the form of a rectangular sheet, one end of which is provided with a closure as described above comprising a fibrous backing material and a pressure sensitive adhesive layer.

### BRIEF DESCRIPTION OF THE DRAWINGS

The invention will now be described, byway of example only, with reference to the accompanying drawings, in which:

FIG. 1 is a side view of a preferred closure according to the invention;

FIG. 2 is a top plan view of the closure of FIG. 1;

FIG. 3 shows the closure of FIG. 1 immediately before it is applied to a wraparound sleeve which has been applied to a pipe;

FIG. 4 shows the overlapped ends of a wraparound sleeve;

FIG. 5 shows a closure according to the invention initially adhered to the wraparound sleeve of FIG. 4;

FIG. 6 shows the closure of FIG. 5 being bonded to the wraparound sleeve by application of heat from a torch; and

FIG. 7 shows a wraparound sleeve according to the invention with an integral closure.

### DETAILED DESCRIPTION OF PREFERRED EMBODIMENTS

The invention will now be described with reference to FIGS. 1 to 7. It is to be noted that the FIGS. 1 to 7 are not drawn to scale with respect to the relative thicknesses of the closures, sleeves and the substrate to which they are applied, or with respect to the thicknesses of the layers comprising the closures and the sleeves.

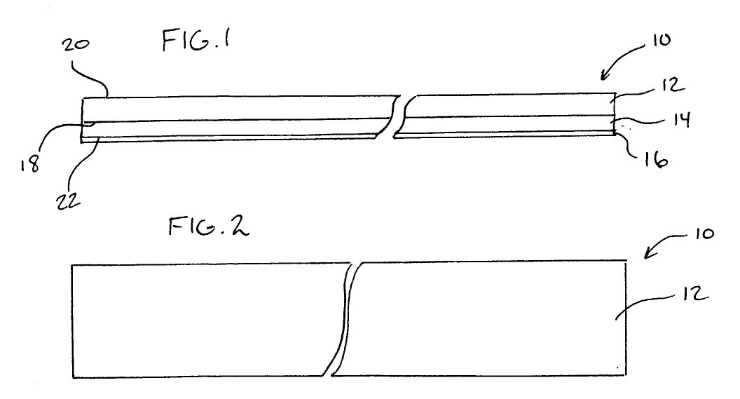

FIGS. 1 and 2 illustrate a preferred closure 10 according to the present invention. As shown in FIG. 1, closure 10 comprises a backing layer 12, a layer of adhesive 14 applied to the backing layer, and a release film 16 applied to the adhesive layer 14. Closure 10 preferably has an elongate, rectangular shape for application along the length of an overlapping joint formed by the ends of a wraparound sleeve.

The backing layer 12 is comprised of a fibrous material and has a first surface 18 and an opposed second surface 20. The backing layer 12 has sufficient dimensional stability such that, during heat shrinking of the wraparound sleeve to which the closure will be applied, the backing layer will resist substantial deformation which would result in pulling apart of the overlapping joint formed by the ends of the wraparound sleeve. Furthermore, the backing layer possesses sufficient resistance to heat such that it will retain its integrity and dimensional stability when it is heated during application to a wraparound sleeve. Preferably, the backing layer should be of a composition able to resist the heat and flame of a torch for a time sufficient to allow the closure to be applied to the underlying wraparound sleeve.

Preferably the backing layer is comprised of an inorganic fibrous material, such as glass fibers (also referred to herein as “fiberglass”). The fibrous material may comprise either a woven or non-woven material. Where it is non-woven, it is preferably in the form of a random mat. Most preferably, the backing layer comprises a woven mat, having either an open weave or a closed weave. An open weave may be more preferred where the substrate to which the wraparound sleeve is applied has a small diameter or an irregular shape, or where there is some axial shrinkage of the sleeve, since a fabric with an open weave may be more flexible and therefore better able to conform to the contours of the sleeve and the underlying substrate. One example of a suitable backing layer comprises a 10 ounce or 14 ounce woven fiberglass fabric.

The backing layer may preferably be coloured, for example by incorporation of a colourant such as a dye, or by including other types of fibers in the backing layer for colouring purposes.

The adhesive layer 14 is applied to the first surface 18 of backing layer 12, preferably by lamination, such that it is in direct contact with the fibrous material comprising backing layer 12. The adhesive comprising layer 14 has sufficient shear resistance such that it resists slippage of the closure 10 relative to the wraparound sleeve during heat shrinking of the sleeve, and so as to resist creeping of the closure relative to the sleeve after heat shrinking of the sleeve is completed.

The adhesive preferably has sufficient tack (pressure sensitivity) at ambient temperatures so that it can be applied to the contours of the wraparound sleeve prior to heating of the closure. As used herein, the term “ambient temperature” refers to the temperatures at which the closure is applied to a heat shrinkable sleeve, the lower limit of the ambient temperature being at least as low as about 0° C. Furthermore, the adhesive also has sufficient pressure-sensitivity at elevated temperature such that it forms a permanent bond between the backing layer and the wraparound sleeve upon application of sufficient heat.

The pressure-sensitive adhesive comprising layer 14 can be selected from one or more adhesive materials selected from the group comprising iso-butylene polymers such as polyisobutylene, polybutene and butyl rubber. These polymers are preferably at least partially crosslinked in order to increase their shear strength, particularly at elevated temperatures. Other preferred adhesive materials include silicones.

One particularly preferred pressure-sensitive adhesive is the partially crosslinked butyl mastic RSL-091 manufactured by RPD Inc. of Evansville, Ind. This adhesive is preferably applied to the fibrous backing layer 12 in a thickness of about 0.03 inches.

The release film 16 preferably comprises a self supporting strippable polymer film which is removed prior to use of the closure 10. Thus, immediately prior to application of the closure 10 to a wraparound sleeve, the adhesive layer 14 has an exposed surface 22 which is available for adhesion to the sleeve, the area of the exposed surface 22 being substantially equal to the total area of the adhesive layer 14.

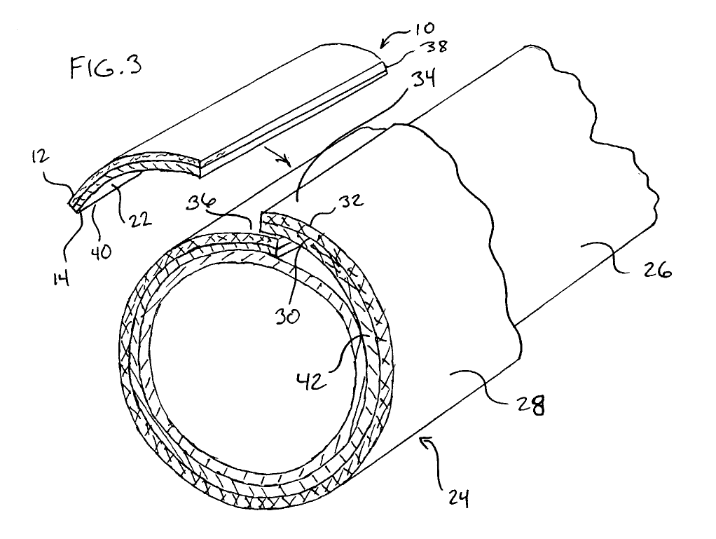

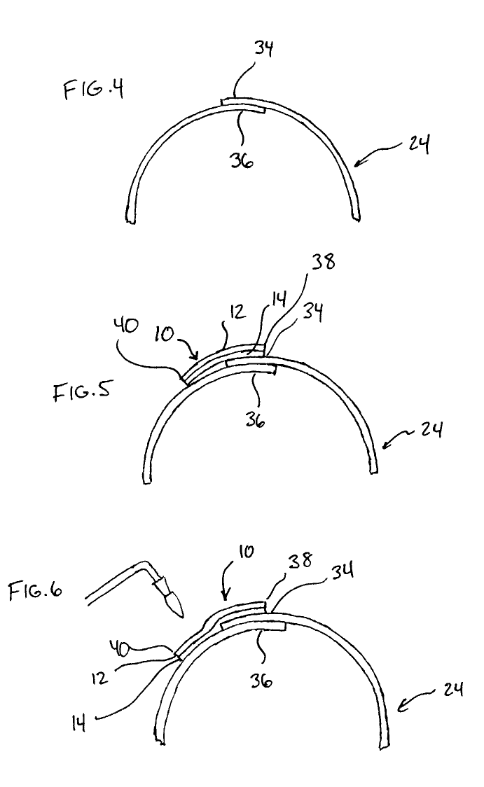

The following is a description of a preferred method of applying a close-fitting protective covering to an article, and in particular a method of applying a heat-shrinkable wraparound sleeve 24 to a joint at which two lengths of pipe 26 are connected, as illustrated in FIGS. 3 to 6. It will be noted that details of the pipe 26 are omitted from FIGS. 4 to 6, as are details of the layers of material comprising the wraparound sleeve 24.

The heat-shrinkable sleeve comprises a flexible sheet 28 having a first surface 30, an opposed second surface 32, a first end portion 34 and a second end portion 36, the end portions being spaced from one another in a longitudinal direction (when the sheet is laid flat).

The flexible sheet 28 is comprised of a dimensionally heat unstable material, preferably a polymer, the material having been stretched in the longitudinal direction from an original heat stable form to a dimensionally heat unstable form capable of moving in the longitudinal direction toward its original heat stable form by the application of heat. As used herein, the term “longitudinal direction” refers to the direction along an axis extending between the end portions 34 and 36 of the flexible sheet 28.

The flexible sheet 28 is wrapped around the pipe 26 by laying the sheet 28 against the pipe 26 and overlapping the first end portion 34 of the sheet 28 over the second end portion 36. This is illustrated in FIGS. 3 and 4.

Next, the closure 10 is applied to the overlapped end portions 34, 36 of flexible sheet 28. The closure 10, with the release film 16 removed, is applied to the overlapped end portions 34, 36 with the exposed surface 22 of adhesive layer 14 directly contacting the sleeve 24. As mentioned above, the adhesive has sufficient pressure sensitivity at ambient temperature such that it initially adheres to the sleeve 24 prior to application of heat. The closure 10 has a first edge 38 which is applied to the first end portion 34 of sheet 24, and an opposed second edge 40 which is applied on the underlapping second portion 36 of the flexible sheet 28. This is illustrated in FIG. 5.

After application of the closure 10 to the sleeve 24, the closure 10 is heated for a sufficient time and to a sufficient temperature to cause the adhesive layer 14 to bond the closure 10 to the first and second end portions 34, 36 of the flexible sheet 28. As illustrated in FIG. 6, heat is preferably applied directly to the second surface 18 of backing layer by a flame from a torch, from example a propane torch.

After the closure 10 is bonded to the sheet 28, the flexible sheet 28 is heated, causing it to shrink in the longitudinal direction toward its original heat stable form and into close-fitting relation with the underlying pipe 26.

Preferably, the first surface of the flexible sheet 28 is provided with a functional coating 42 to improve contact between the flexible sheet 28 and the underlying substrate and to fill any voids. The functional coating preferably comprises a hot-melt adhesive or a mastic.

As mentioned above, the adhesive layer 14 has sufficient shear resistance to prevent substantial slippage and creeping of the closure 10 relative to the flexible sheet 28 during and after heating thereof, and the dimensional stability of the backing layer is sufficient to resist substantial deformation in the longitudinal direction during and after heating of the flexible sheet.

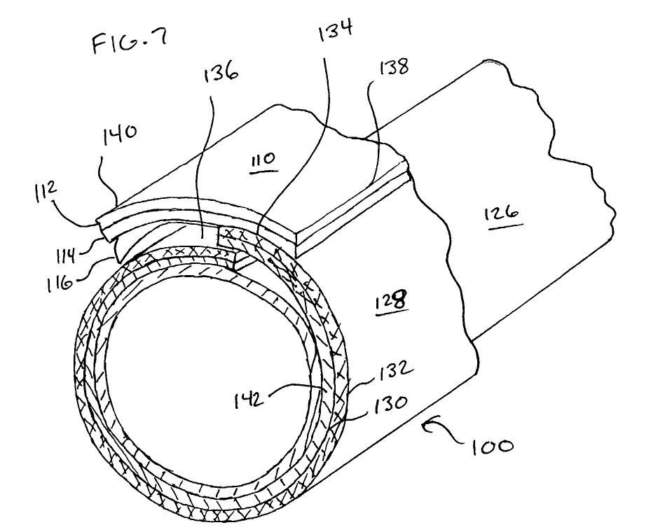

The closure discussed above with reference to FIGS. 1 to 6 is in the form of an elongate strip which is applied to the sleeve 24 after it is wrapped around pipe 26. FIG. 7 illustrates an alternate type of closure in which the closure is attached to the sleeve before the sleeve is wrapped around the substrate. The sleeve/closure 100 illustrated in FIG. 7 comprises a closure strip 110 and a flexible sheet 128. The closure strip 110 has a first edge 138 which is disposed on the first end portion 134 of the flexible sheet 128. The second edge 140 of closure strip 110 comprises a free edge extending beyond the first end portion 134. In the embodiment shown in FIG. 7, a release film 116 (shown partially peeled from adhesive layer 114) is provided between the free edge 140 and the first end portion 134 of flexible sheet 128, thereby preventing premature adhesion of adhesive layer 114 to the second end portion 136 of flexible sheet 128. As with sleeve 24 described above, the flexible sheet 128 has a first surface 130 and a second surface 132, wherein a functional coating 142 is provided on the first surface 130.

Although the invention has been described by reference to certain preferred embodiments, it is not to be limited thereto. Rather, the invention is intended to include all embodiments which may fall within the scope of the following claims.

What is claimed is:

1. A closure for application to a heat shrinkable, wraparound sleeve, comprising:
(a) a dimensionally stable, heat resistant backing layer having a first surface and an opposed second surface, the backing layer being comprised of a fibrous material and having sufficient heat resistance to retain its integrity and dimensional stability when it is heated during application of the closure to the wraparound sleeve, the dimensional stability of the backing layer being sufficient to resist substantial deformation in at least one direction during heat shrinking of the wraparound sleeve around an article; and
(b) a layer of pressure sensitive, shear resistant adhesive applied to the first surface of the backing layer, the adhesive layer being in direct contact with the fibrous material at the first surface, the adhesive layer having sufficient shear resistance such that it resists slippage and creeping relative to the sleeve during and after heat shrinking of the wraparound sleeve, the adhesive layer having an exposed surface area which, immediately prior to application of the closure to the sleeve, is exposed and available for adhesion to the sleeve, the exposed surface area being substantially equal to a total area of the adhesive layer.

2. The closure according to claim 1, further comprising a release film covering the exposed surface area of the adhesive layer, the release film being removable prior to application of the closure to the sleeve.

3. The closure according to claim 1, wherein the backing layer is sufficiently flame-resistant such that it retains its integrity and dimensional stability when a flame is used during application of the closure to the sleeve.

4. The closure according to claim 1, wherein the backing layer is an inorganic material.

5. The closure according to claim 1, wherein the backing layer is comprised of glass fibers.

6. The closure according to claim 1, wherein the backing layer comprises a woven or non-woven fiberglass fabric.

7. The closure according to claim 1, wherein the adhesive is pressure-sensitive at ambient temperatures.

8. The closure according to claim 1, wherein the adhesive is pressure-sensitive at an elevated temperature to which the closure is heated during application to the sleeve.

9. The closure according to claim 1, wherein the adhesive is polymeric and is at least partially crosslinked.

10. The closure according to claim 1, wherein the adhesive is selected from the group comprising isobutylene polymers and silicones.

11. A heat-shrinkable wraparound covering to be applied to an article in wrapping relation thereto, the covering comprising:
(a) a flexible sheet having a first surface, an opposed second surface, a first end portion and a second end portion, the end portions being spaced from one another in a longitudinal direction by a sufficient distance such that they can be brought into overlapping relation when the sheet is applied to the article, the sheet being comprised of a dimensionally unstable material, the material having been stretched in the longitudinal direction from an original heat stable form to a dimensionally heat unstable form capable of moving in the longitudinal direction toward its original heat stable form by the application of heat; and
(b) a closure strip having one edge disposed on the first end portion of the flexible sheet and an opposite free edge extending beyond the first end portion, the closure strip being of sufficient width that when the end portions of the sheet are brought together and the first end portion having the closure strip is overlapped on the second end portion, the free edge of the closure strip can be applied on the second end portion and bonded thereto by direct heating;
wherein the closure strip comprises:
(i) a dimensionally stable, heat resistant backing layer having a first surface and an opposed second surface, the backing layer being comprised of a fibrous material and having sufficient heat resistance to retain its integrity and dimensional stability when heat is applied thereto during bonding of the free edge of the closure strip to the second end portion of the flexible sheet, the dimensional stability of the backing layer being sufficient to resist substantial deformation in the longitudinal direction during heat shrinking of the flexible sheet; and
(ii) a layer of pressure sensitive, shear resistant adhesive applied to the first surface of the backing layer, the adhesive layer being in direct contact with the fibrous material at the first surface, the adhesive layer having sufficient shear resistance such that it prevents substantial slippage and creeping of the closure strip relative to the second end portion during and after heat shrinking of the flexible sheet, the adhesive layer having an exposed surface area between the free edge of the closure strip and the first end portion of the flexible sheet which, immediately prior to application of the closure strip to the second end portion of the flexible sheet, is exposed and available for adhesion to the sleeve, the exposed surface area being substantially equal to a total area of the adhesive layer between the free edge of the closure strip and the first end portion of the flexible sheet.

12. The heat-shrinkable wraparound covering according to claim 11, wherein the closure strip is disposed on the first surface of the flexible sheet, and wherein the covering further comprises:
(c) a functional coating covering the second surface of the flexible sheet, at least in an area between the end portions.

13. The heat-shrinkable wraparound covering according to claim 12, wherein the functional coating is a hot-melt adhesive.

14. A method of applying a close-fitting protective covering to an article, comprising:
(a) providing a flexible sheet having a first surface, an opposed second surface, a first end portion and a second end portion, the end portions being spaced from one another in a longitudinal direction, the sheet being comprised of a dimensionally heat unstable material, the material having been stretched in the longitudinal direction from an original heat stable form to a dimensionally heat unstable form capable of moving in the longitudinal direction toward its original heat stable form by the application of heat;
(b) providing a closure strip comprising:
(i) a dimensionally stable, heat resistant backing layer having a first surface and an opposed second surface, the backing layer being comprised of a fibrous material; and
(ii) a layer of pressure sensitive, shear resistant adhesive applied to the first surface of the backing layer, the adhesive layer being in direct contact with the fibrous material at the first surface;
(c) wrapping the flexible sheet around the article by laying the sheet against the article and overlapping the first end portion of the sheet over the second end portion;
(d) applying a first edge of the closure strip to the first end portion of the flexible sheet;
(e) applying a second edge of the closure strip on the second end portion of the flexible sheet, the second edge being opposite the first edge;
(f) applying sufficient heat to the closure strip to cause the adhesive layer to bond the closure strip to the first and second end portions of the flexible sheet; and
(g) applying sufficient heat to the flexible sheet to cause the flexible sheet to shrink in the longitudinal direction toward its original heat stable form and into close-fitting relation with the article;
wherein the adhesive layer of the closure strip has sufficient shear resistance to prevent substantial slippage and creeping of the closure strip relative to the second end portion of the flexible sheet during and after heating of the flexible sheet, and wherein the dimensional stability of the backing layer is sufficient to resist substantial deformation in the longitudinal direction during ans after heating of the flexible sheet.

15. The method according to claim 14, wherein step (d) is performed prior to step (c), such that the first edge of the closure strip is disposed on the first end portion of the flexible sheet before the flexible sheet is wrapped around the article, and such that the second edge of the closure strip comprises a free edge extending beyond the first end portion before the flexible sheet is wrapped around the article.

16. The method according to claim 14, wherein step (c) is performed prior to step (d), such that the closure strip is applied to both the first and second end portions of the flexible sheet after the flexible sheet is wrapped around the article.
